(19) United States
(12) Patent Application Publication
(10) Pub. No.: US 2013/0047860 A1
(43) Pub. Date: Feb. 28, 2013

(54) Anti-Rust Case (ARC)

(71) Applicant: Charles Allan Lawhorne, Bridgeport, AL (US)

(72) Inventor: Charles Allan Lawhorne, Bridgeport, AL (US)

(21) Appl. No.: 13/595,996

(22) Filed: Aug. 27, 2012

Related U.S. Application Data
(60) Provisional application No. 61/575,800, filed on Aug. 29, 2011.

(51) Int. Cl. B01D 53/04

(52) U.S. Cl. 96/118

(57) ABSTRACT

My product, called the ARC (Anti-rust case) is a case, which contains oxygen and moisture absorbing desiccant. The desiccant, being activated clay, silica gel, and molecular sieve, is contained inside the case along with products that need to remain free of rust. The main object of the case is to prevent rust from forming on the blades of a manual shaver or straight razor.

The main components of this product are the case, which restrict air flow, and the desiccant which absorb oxygen and moisture. Without the presence of moisture the formation of rust is slowed so that the razors blades can perform its purpose longer.

As pertaining to prior art, I have found no products that are similar.

### CROSS REFERENCE TO RELATED APPLICATIONS

Provisional patent application No. 61/575,800 Filing date Aug. 29, 2011

### STATEMENT OF FEDERALLY SPONSORED RESEARCH

Not applicable

### NAMES OF JOINT RESEARCH

Not applicable

### REFERENCE TO SEQUENCE LISTING

Not applicable

### BACKGROUND OF THE INVENTION

This invention relates to manual shavers and the prevention of rust on the shavers blades. Rust will form on the blades when they are exposed to moisture and oxygen over a prolonged period of time. The Anti-Rust Case protects the blades from the environment that promotes rust, thereby allowing the shavers blades to be useable longer.

### BRIEF SUMMERY OF THE INVENTION

A purpose of the invention is to provide a case to contain a manual shaver. The case creates a rust-retarding environment that slows the formation of rust on the shavers blades and allows the shaver to perform its purpose for a longer period of time. When rust forms on the blades of the shaver, the rust prevents the blades from shaving as well as blades without rust.

One advantage of the invention is to allow the shavers blades to form less rust during the useful life of the shaver.

The invention is a device and method for preventing the formation of rust on the blades of a manual shaver.

### BRIEF DESCRIPTION OF THE SEVERAL VIEWS OF THE DRAWING

FIG. 1 is the cases lid.

FIG. 2 is the separation plate. This plate separates the desiccant pack, FIG. 3, from the shaver. The shaver sets on top of the separation plate, FIG. 2. The separation plate, FIG. 2, sets inside the case, FIG. 4.

FIG. 3 is the desiccant pack and contains activated clay, silica gel, and molecular sieve.

FIG. 4 is the case that contains the desiccant pack, FIG. 3, inside the bottom of the case. The separation plate, FIG. 2, fits inside the case, FIG. 4, to separate the desiccant pack from the shaver. The separation plate, FIG. 2, is the resting platform for the shaver.

### DETAILED DESCRIPTION OF THE INVENTION

The ARC (anti-rust case), is a case that contains a desiccant pack that consists of activated clay, silica gel and molecular sieve. These ingredients in the desiccant pack are oxygen and moisture absorbing agents.

The purpose for the case is to prevent the premature formation of rust on the contents of the case.

One purpose of the invention is to retard the formation of rust on the blades of a manual shaver.

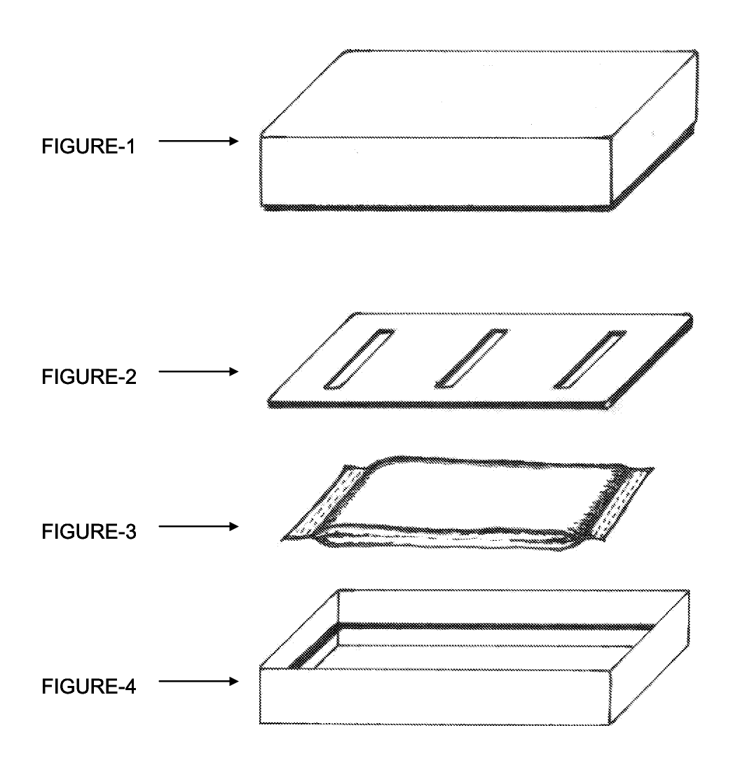

In the drawings, FIG. 1 is the lid of the case, FIG. 2 is the separation plate. The separation plate, FIG. 2, separates the desiccant pack, FIG. 3, from the area that contains the shaver. The shaver sets on top of the separation plate, FIG. 2.

FIG. 3 is the desiccant pack, and FIG. 4 is the case which contains the desiccant pack, FIG. 3.

When a manual shaver is placed inside the case, the Anti-rust case provides an environment that retards the formation of rust on the blades of the shaver. Under normal conditions rust will begin to form on steel when the steel is exposed to moisture and oxygen. The desiccant inside the case absorbs moisture and oxygen and slows the formation of rust on the blades of the shaver.

When a shavers blades become rusted, the rust on the cutting edge of the blades, will prevent the blades from cutting properly. The rust will scratch the surface area of what is being shaved, in this case, the skin of the person being shaved.

1. I claim the invention will retard the formation of rust on the contents of the case. I claim the invention will retard the formation of rust on the blades of a manual shaver. I claim the desiccant in the case will provide an environment that retards the formation of rust on the contents of the case.
